(19) United States
(12) Patent Application Publication
(10) Pub. No.: US 2026/0247084 A1
(43) Pub. Date: Aug. 20, 2026

(54) Switching a Hearing Device Between Two Sets of Actuator Strengths

(71) Applicant: Sonova AG, Staefa (CH)

(72) Inventors: Stephan Müller, Uster (CH); Simon Canales, Stäfa (CH)

(21) Appl. No.: 19/413,575

(22) Filed: Dec. 9, 2025

(30) Foreign Application Priority Data
Feb. 14, 2025 (EP) 25158013.0

(51) Int. Cl. H04R 25/00

(52) U.S. Cl. CPC H04R 25/43; H04R 25/353; H04R 25/356; H04R 25/40; H04R 2225/41; H04R 2225/61; H04R 2460/01

(57) ABSTRACT

A method for controlling a hearing device comprises: processing an audio stream with the hearing device into a processed audio stream with at least one actuator, which at least one actuator is controlled by an actual set of actuator strengths; outputting the processed audio stream to a user; inputting the audio stream into at least one acoustic environment classifier of the hearing device, which outputs at least one acoustic environment classification value indicative of an acoustic environment of the user; determining a new set of actuator strengths based on the at least one acoustic environment classification value; receiving at least one input stream; determining at least one change rate for the at least one input stream; determining at least one change parameter for an actuator change from the actual set of actuator strengths to the new set of actuator strengths; and controlling the at least one actuator.

### RELATED APPLICATIONS

The present application claims priority to EP Patent Application No. EP25158013.0, filed Feb. 14, 2025, which is hereby incorporated by reference in its entirety.

### BACKGROUND INFORMATION

Hearing devices may be used for compensating hearing deficiencies of a user and may provide several features that aim to facilitate speech intelligibility, improve sound quality, reduce noise level or adjust general volume. Many functionalities are designed to benefit the user’s hearing performance in very specific situations. Hearing devices nowadays are usually designed with an automatic steering system, that aim to determine the optimal activation of a feature based on an acoustic environment classifier. Several features with similar optimal activation scenarios are summarized in so called hearing programs.

When the acoustic environment changes, the hearing device may change automatically between an actual hearing program and a new hearing program by fading out the actual hearing program and fading in the new hearing program. However, there may be a missing flexibility in reacting to changes in the acoustic environment, since scene transitions may occur in a rather sudden or in a rather smooth manner with many variations.

In an example to illustrate the problem, the hearing device user is at a cocktail party with loud music, loud conversations and lots of noises. The actuators of the hearing device may be stabilized in a state that optimizes speech intelligibility and loudness comfort. In a first case, when the user is exiting the party into the street, the acoustic environment very suddenly changes and the user needs environmental awareness, which should be provided quickly. The change between the hearing programs is optimally set to be quickly adapting. In a second case, if during a conversation of the user at the cocktail party, a speech pause occurs, the hearing device shall retain the actual hearing program to not interfere with the continuation of the conversation. A possible change should be set to be rather slowly adapting.

### BRIEF DESCRIPTION OF THE DRAWINGS

Below, embodiments are described in more detail with reference to the attached drawings.

FIG. 1 schematically shows a hearing device.

FIG. 2 schematically shows a functional diagram of a hearing device according to an embodiment.

FIG. 3 shows diagrams illustrating quantities during the performance of a method according to an embodiment.

The reference symbols used in the drawings, and their meanings, are listed in summary form in the list of reference symbols. In principle, identical parts are provided with the same reference symbols in the figures.

### DETAILED DESCRIPTION

Described herein are a method, computer program and computer-readable medium for controlling a hearing device as well as to the hearing device.

It is a feature described herein to increase the comfort and usability of a hearing device.

A first aspect relates to a method for controlling a hearing device, in particular for switching between an actual hearing program and a new hearing program or between an actual mixing of several hearing programs and a new mixing of several hearing programs. The method may be performed automatically by the hearing device.

In general, a hearing device is adapted for receiving an audio stream, processing the audio stream and outputting the audio stream to the user, i.e., the user wearing the hearing device. The hearing device also may have two parts, each part for one ear of the user. The parts may be in data communication with each other. The audio stream may be provided by a microphone of the hearing device. The processed audio stream may be output by a loudspeaker of the hearing device, which also may be called receiver. The hearing device may be a hearing aid, which is a hearing device adapted for processing the audio stream, such that a hearing loss of the user is compensated.

According to an embodiment, the method comprises: receiving an audio stream in the hearing device. The audio stream may be generated by one or more microphones of the hearing device. The audio stream, and more general the stream mentioned below, may be digital data streams, which comprise data, such as audio data, wherein the data values are associated with time values. The data values are timely ordered.

According to an embodiment, the method comprises: processing the audio stream with the hearing device into a processed audio stream with one or more actuators of the hearing device, which actuators are controlled with an actual set of actuator strengths, which control how the actuators process the audio stream. The actuators may be provided by software and/or hardware, such as a DSP, a processor, etc. Each actuator may have a set of control parameters and/or settings, which are called actuator strengths.

According to an embodiment, the method comprises: outputting the processed audio stream with the hearing device to a user of the hearing device. The processed audio stream may be output by a loudspeaker, which may be arranged in an ear channel of the user.

According to an embodiment, the method comprises: inputting the audio stream into at least one audio environment classifier of the hearing device, which outputs at least one acoustic environment classification value indicative of an acoustic environment of the user; and determining a new set of actuator strengths based on the at least one acoustic environment classification value. The settings of the one or more actuators may be determined based on classifiers, which are run in the hearing device. The classifiers may be based on software and/or hardware.

In general, a classifier receives input data and outputs classification values, which classify the input data. Classification values may be discrete values or may comprise probability values. For example, an acoustic environment classification value may indicate, whether an acoustic environment is present (such as yes/no) or may provide a probability of the presence of an acoustic environment (such as 0…1).

In general, the actuator strengths may control how the at least one actuator processes the audio stream.

When a specific acoustic environment is identified, then the actuator strengths of the one or more actuators may be changed to a set of actuator strengths, which may be stored in the hearing device with respect to the identified acoustic environment. The determination of the new set of actuator strengths also may be based on mixing several sets of actuator strengths, which are stored in the hearing device. The mixing may be based on probabilities provided by acoustic environment classification values.

According to an embodiment, the method comprises: receiving at least one input stream determined from sensor data of a sensor of the hearing device. The at least one input stream may be indicative of an environmental and/or personal situation (such as activity) of the user. The input stream may be different from the audio stream. The environmental and/or personal situation may be different from the acoustic environment classification provided by the audio environment classifier.

According to an embodiment, the method comprises: determining at least one change rate for the at least one input stream; and determining at least one change parameter for an actuator change from the actual set of actuator strengths to the new set of actuator strengths. The input stream may contain timely ordered data, from which a change of the environmental and/or personal situation of the user can be deduced. The change rate may be a value, which shows how fast the environmental and/or personal situation is changing. The change rate of an input stream may be determined from discrete derivatives of the input stream considered as a function over time. The change rates may be seen as slopes of the input streams and/or are indicative of a magnitude of a change in a specific environmental and/or personal situation. The change parameter may be indicative of an overall magnitude of change.

The one or more change rates may be input into a function, which outputs a change parameter for the actuator change. The change parameter indicates how soon and/or how fast the actuator change should take place. The actuator change may parametrize the start time point, when the changing of the actuator strengths starts, the end time point, when the changing of the actuator strengths is finished, and the slew rates, how the actuator strengths change between the start time point and the end time point. Slew rates may be provided in dB/s or 1/s. In general, the actuator change may parametrize a timely behavior of the change of the actuator strengths.

For example, the function, which outputs the change parameter, may comprise a sum of the change rates. The change parameter may be modelled such that the higher its value, the more likely an actual change in the user’s behaviour, location and/or acoustic environment is.

The change parameter is used to determine the slew rates, at which the settings of the hearing device, i.e., the actuator strengths, adapt to a detected change in an environmental and/or personal situation of the user.

The at least one change parameter may control the timely behavior of the actuator change. This may comprise the start time point, the end time point, the speed and/or form of the slew rates of the actuator strength, etc.

According to an embodiment, the method comprises: controlling the actuator, such that the actual set of actuator strengths change to the new set of actuator strengths in dependence of the at least one change parameter. The change of the actuator strengths is performed with the parameters determined with the one or more change parameters, such as start time point, the end time point and/or the slew rates for the actuator strengths.

According to an embodiment, the at least one change parameter comprises a length of a time delay until a start of the actuator change. The start time of the actuator change may be the actual time plus the time delay. The higher the change parameter, the shorter the time delay. The method then may comprise: waiting the time delay before starting to change the actuator strengths.

In general, the actuator change may be controlled to be faster, when the one or more change parameters are higher and may be controlled to be slower, when the one or more change parameters are lower.

According to an embodiment, the at least one change parameter comprises at least one slew rate for the actuator strengths. The slew rate determines how fast the actuator strengths change. As higher the at least one change parameter, as higher the at least one corresponding slew rate. The method then may comprise: changing the actuator strengths from the actual set of actuator strengths to the new set of actuator strengths with the at least one slew rate.

According to an embodiment, the method comprises: receiving at least two input streams determined from sensor data of at least two sensors of the hearing device. The two input streams may be indicative of and/or related to different types of situations and/or environments of the user. Then, a change rate may be determined for each input stream and the at least one change parameter may be determined from the change rates of the input streams, for example via a linear function of the change rates.

The information from multiple inputs and/or sensors may be combined to determine the change parameter. It may be that the input streams are normalized to account for their individual range of information.

According to an embodiment, one or more of the input streams are based on at least one of: audio data of a microphone, acceleration data of an accelerator, health data of a health sensor. The input streams may be one of the following: an acoustic scene classifier, an acoustic level estimation, a physical activity classification, an estimation of sound source location, an estimation of the number of sound sources, a rating of acoustic scene complexity.

In general, a motion sensor may be any suitable sensor configured to provide motion data indicative of a movement of a user wearing the hearing device. In some examples, the motion sensor can include an accelerometer and/or a gyroscope and/or a magnetometer and/or an inertial measurement unit (IMU).

In general, a physiological sensor may be any suitable sensor configured to provide physiological data indicative of a physiological property of the user. In some examples, the physiological sensor comprises an optical sensor, e.g., a photoplethysmography (PPG) sensor configured to detect a blood property. In some examples, the physiological sensor comprises a bioelectric sensor comprising at least one electrode configured to detect a bioelectric signal, e.g, an electrocardiogram (ECG) sensor and/or an electroencephalogram (EEG) sensor and/or an electrooculography (EOG) sensor. In some examples, the physiological sensor comprises a skin impedance sensor and/or a body temperature sensor.

According to an embodiment, at least one input stream is or is determined from the audio stream, which is provided by a microphone of the hearing device. However, the change rates may be determined from other classifiers and/or estimators than those used for acoustic environment classification. For example, the at least one input stream may be an overall acoustic level estimation.

According to an embodiment, at least one input stream is or is determined from a further sensor data stream from a sensor different from a microphone of the hearing device. The further sensors may be an accelerator and/or a health data sensor, which may be integrated into the hearing device.

According to an embodiment, at least one input stream is determined by classification values output by a classifier, which are determined by the classifier over time. The output values of the classifier at different time points may be concatenated into the input stream.

According to an embodiment, the classifier is a classifier, for example the acoustic environment classifier, which outputs are used for determining a new set of actuator strengths. In this case, the change rates for the classifier, which are used for determining the set of actuator strengths, also may be used to determine how the actuator change takes place.

According to an embodiment, the new set of actuator strengths is determined by a hearing program, which is stored in the hearing device. Several sets of actuator strengths may be stored in the hearing device, wherein each set is associated with a specific acoustic environment of the user. Such a set of actuator strengths may be called hearing program. The set associated with a specific acoustic environment may be used as new set of actuator strengths, when the specific acoustic environment is detected. The actuator change from an actual hearing program to a new hearing program may be seen as a fading from the actual program to the new program.

According to an embodiment, the new set of actuator strengths is determined from a mixture of hearing programs stored in the hearing device. It is also possible that, when a mixture of acoustic environment is detected, then hearing programs associated with acoustic environments in the mixture are mixed. This may mean that actuator strengths of different hearing programs are mixed, such as weighted and summed.

In general, two variants for the activation and transition between hearing programs may be applied: mixing and fading. Fading may refer to a cross-fading mechanism, which gradually increases or decreases each actuator strength until the target strength (i.e., the actuator strength from the new set) is reached. Mixing may refer to a hearing program activation being gradually dependent on a gradually changing criteria such as a probability value output by a classifier associated with the hearing program.

According to an embodiment, the actuators comprise at least one of: an actuator for frequency dependent amplification; an actuator for frequency shifting and compressing; an actuator for frequency compressing; an actuator for noise canceling; an actuator for beam forming. Actuators may refer to all software and hardware components, which process the audio stream based on settings in the hearing device.

A further aspect relates to a computer program for controlling a hearing device, which, when being executed by at least one processor, is adapted to carry out the steps of one of the previous methods. For example, the computer program may be executed in the hearing device.

A further aspect relates to a computer-readable medium, in which such a computer program is stored. In general, a computer-readable medium may be a hard disk, a USB (Universal Serial Bus) storage device, a RAM (Random Access Memory), a ROM (Read Only Memory), an EPROM (Erasable Programmable Read Only Memory) or a FLASH memory. A computer-readable medium may also be a data communication network, e.g., the Internet, which allows downloading a program code. The computer-readable medium may be a non-transitory or transitory medium. The computer-readable medium may be a memory of the hearing device.

A further aspect relates to a hearing device with a microphone, a sound output device, at least one actuator and at least one classifier. The microphone, the at least one actuator and the at least one classifier may be integrated in a housing of the hearing device. The sound output device, such as a loudspeaker, may be integrated into the housing or may be connected via a cable with the housing. The hearing device is adapted for performing the method such as described herein.

It has to be understood that features of the method as described in the above and in the following may be features of the hearing device, computer program and the computer-readable medium as described in the above and in the following, and vice versa.

These and other aspects will be apparent from and elucidated with reference to the embodiments described hereinafter.

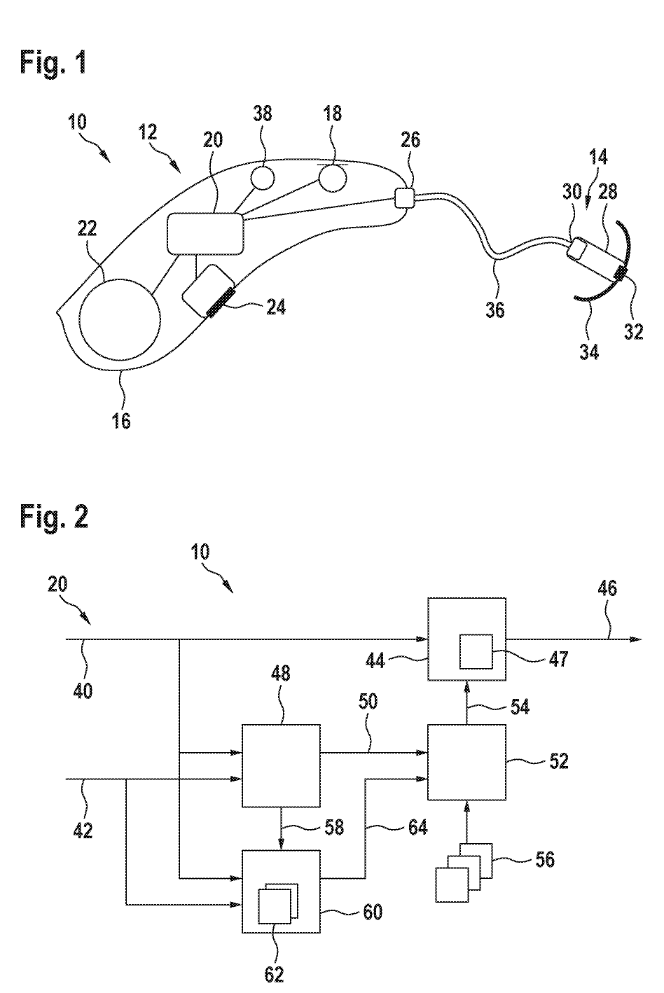

FIG. 1 shows a hearing device 10, in particular a hearing aid, which is composed of a behind-the-ear part 12 and an in-the-ear part 14.

The behind-the-ear part 12 has a housing 16 adapted to be carried behind the ear of a user. A microphone 18, a computing device 20, a battery 22, a knob 24 and a connector 26 are integrated into the housing 16. The computing device 20 is powered by the battery 22 and/or comprises a software processor, a signal processor and a memory. The knob can be actuated by a user and/or be used as user interface for switching the hearing device 10 on and off and for optionally changing settings of the hearing device 10.

The in-the-ear part 14 comprises a housing 28 adapted to be plugged into the ear channel of the user. A connector 30 and sound output device 32, like a loudspeaker and/or receiver, are integrated into the housing 28. The housing 28 comprises a dome 34 for occluding the ear channel. The in-the-ear part 14 is connected via a cable 36 with the behind-the-ear part 12, which cable 36 is connected to the connectors 26, 30.

There may be one or more further sensors 38, such as an acceleration sensor or health sensor, integrated into the housing 16.

The hearing device 10 acquires an audio signal with the microphone 18 from an environment of the user, which is transformed into an audio stream in the computing device 20. The computing device 20 processes the audio stream into a processed audio stream, which is transformed back into an audio signal, which is provided via the cable 36 to the sound output device 32 and output to the user.

FIG. 2 shows a functional diagram of the computing device 20. With respect to FIG. 2, also a method for controlling the hearing device 10 is described.

An audio stream 40 of the microphone 18 and an input stream 42 of a further sensor 38, such as an acceleration sensor or health sensor, are received in the computing device 20. The audio stream 40 is processed by one or more actuators 44 into a processed audio stream 46, which is then output to the loudspeaker 32. The actuator 44 is controlled by an actual set of actuator strengths 47, which are settings of the actuator 44, which control how the actuator 44 processes the audio stream 40.

There may be a plurality of actuators 44, each of which processes the audio stream 40 and each of which has individual actuator strengths. For example, the one or more actuators 44 may be adapted for frequency dependent amplification, frequency shifting and compressing, frequency compressing, noise canceling and/or beam forming.

The audio stream 40 and optionally the input stream 42 are input into one or more classifiers 48, which comprise an acoustic environment classifier and/or are adapted for acoustic environment classification. The one or more classifiers 48 output acoustic environment classification values 50, each of which is indicative of a specific acoustic environment of the user.

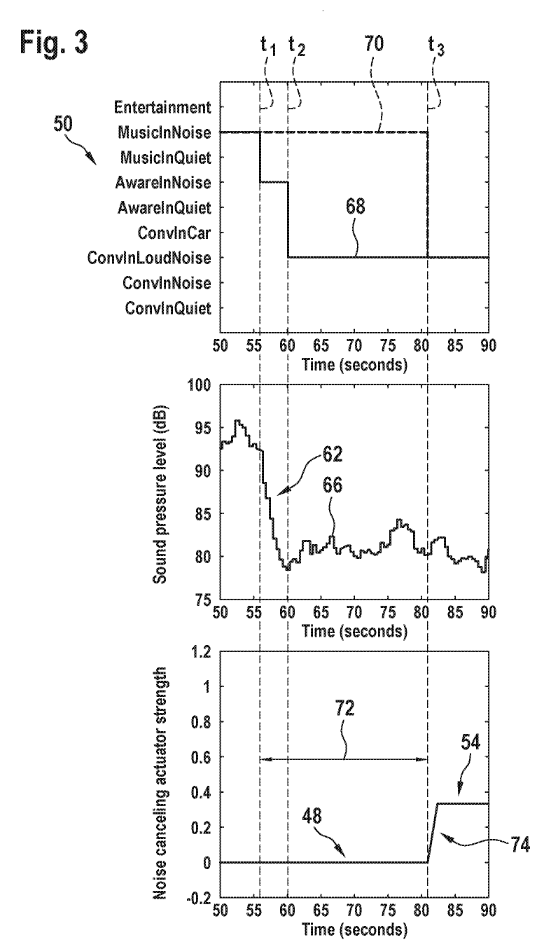

FIG. 3 shows three diagrams, which relate to an example, where firstly music is played until the time point t₁ and at time point t₂ a conversation starts, while all the time there is a noise background. At time point t₃, an actuator change starts.

In the upper diagram of FIG. 3, several environment classification values 50 are depicted on the y-axis. The classification values 50 relate to the acoustic environments Entertainment, Music in Noise, Music in Quiet, Aware In Noise, Aware in Quiet, Conversation In Car, Conversation Load Noise, Conversation In Noise, and Conversation in Quiet. Each environment classification value 50 indicates a probability that the respective acoustic is present. The environment classification values 50 may be determined solely from the audio stream 40 alone, however, also the input stream 42 may be used additionally as input to the respective classifier 48.

Returning to FIG. 2, the acoustic environment classification values 50 are input into a program selector 52, which determines a new set of actuator strengths 54 based on the at least one acoustic environment classification value 50. The new set of actuator strengths 54 are determined by the program selector 52 from hearing programs 56, which are stored in the computing device 20.

There may be a hearing program 56 for each acoustic environment classification value 50, for example for each acoustic environment, such as listed above. It may be that the new set of actuator strengths 54 is determined from a single hearing program 56 or from a mixture of hearing programs 56.

FIG. 3 shows further, which acoustic environment has the maximal acoustic environment classification value 50 (curve 68) and which hearing program 56 will be activated by the method (curve 70). Curve 68 depicts the actual acoustic environment. Curve 70 the actual selected hearing program.

The input stream 42 and optionally the audio stream 40 and/or optionally a further input stream 58 of classification values are input into a change rate detector 60, which determines a change rate 62 for each of the input streams 40, 42, 58.

In the middle diagram of FIG. 3, an example of an input stream 66 in the form of a sound pressure level over time is shown. The input stream 66 is determined from the audio stream 40, which is provided by the microphone 18, wherein the sound pressure level of the audio stream 40 is determined.

As can be seen, when the music stops at t₁, the sound pressure level and the input stream 66 drops, since the persons in the vicinity of the user lower their voices. The change rate 62 of the input stream 66 may be the absolute value of the average in a sliding window of the derivative of the input stream 66. Thus, the change rate 62 increases after time point t₁.

It is also possible that an input stream 42 is or is determined from a further sensor data stream 42 from a sensor 38 different from the microphone 18 of the hearing device 10.

A further possibility is that the input stream 58 is determined by classification values output by the one or more classifiers 48, which are determined by the one or more classifiers 48 over time. For example, the respective classifier 48 is a classifier, which outputs 50 are used for determining the new set of actuator strengths 54.

In general, at least two input streams 40, 42, 58, for example from sensor data of at least two sensors 18, 38 of the hearing device 10, may be evaluated by the change rate detector 60. The change rate detector 60 may determine a change rate 62 for each input stream 40, 42, 58.

From the one or more change rates, the change rate detector 60 determines at least one change parameter 64 for an actuator change from the actual set of actuator strengths 47 to the new set of actuator strengths 54.

In general, the one or more change parameters 64 model a timely behavior of the actuator change, for example, when the actuator change starts, when it ends, how fast the actuator strengths are changing, etc. The one or more change parameters 64 may comprise time constants and slew rates for the actuator change.

The program selector 52 then sets the actual actuator strengths 47 in such a way, that the actual set of actuator strengths 47 changes to the new set of actuator strengths 54 according to the change parameter 64. The time parameters of the change are set in dependence of the change parameter 64.

As shown in the lower diagram of FIG. 3, one change parameter 64 may be a time delay 72 until a start of the actuator change. In this case, the program selector 52 waits for the time delay 72, until the time point t₃, before starting to change the actuator strengths 47.

The lower diagram of FIG. 3 depicts the actuator strength for noise canceling 74. Before the time point t₃, the actuator strength 54 is at the value of the actual set of actuator strengths 47. After the time point t₃, the actuator strength 54 raises to the value of the new set of actuator strengths 54 and stays at this value. The speed of the raising is controlled by a slew rate 74. Also this slew rate 74 may depend or may be part of the at least one change parameter 64.

Returning to the example of the cocktail party mentioned in the beginning, when the user leaves the party, the input streams 40, 42, 58 indicate a rather large change in the acoustic environment, in the acoustic level estimations (such as signal-to-noise ratio, noise floor), in the user’s physical activity (moving to the exit, higher accelerations, increasing heart rate, larger changes of the electrical brain activity), in the number and location of sound sources and in the rating of scene complexity. Consequentially, the change rates 62 are determined large, thus the actuator change should be done quickly and the actuator strengths 47 are quickly changed.

When the conversation of the user is interrupted, the input streams 40, 42, 58 indicate a rather small change in the acoustic environment, in the acoustic level estimations (noise floor remains the same), in the user’s physical activity (slow movement and acceleration steady heart rate, smaller changes of the electrical brain activity), in the number and location of sound sources (other than the conversation partner) and in the scene complexity. Consequentially, the change rates 62 are determined small, thus the actuator change should be done slowly and the actuator strengths 47 are slowly changed or are not changed at all, not compromising a re-engagement in the conversation.

While the embodiments described herein have been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practicing the claimed invention from a study of the drawings, the disclosure, and the appended claims. In the claims, the word “comprising” does not exclude other elements or steps, and the indefinite article “a” or “an” does not exclude a plurality. A single processor or controller or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

### LIST OF REFERENCE SYMBOLS

10 hearing device

12 behind-the-ear part

14 in-the-ear part

16 housing

18 microphone

20 computing device

22 battery

24 knob

26 connector

28 housing

30 connector

32 sound output device, loudspeaker

34 dome

36 cable

38 further sensor

40 audio stream

42 sensor input stream

44 actuator

46 processed audio stream

47 actual set of actuator strengths

48 classifier

50 acoustic environment classification values

52 program selector

54 new set of actuator strengths

56 hearing program

58 further input stream

60 change rate detector

62 change rate

64 change parameter

66 sound pressure level input stream

68 actual acoustic environment

70 actual selected hearing program

72 time delay

74 slew rate

What is claimed is:

1. A method for controlling a hearing device, the method comprising:
receiving an audio stream in the hearing device;
processing the audio stream with the hearing device into a processed audio stream with at least one actuator of the hearing device, which at least one actuator is controlled by an actual set of actuator strengths;
outputting the processed audio stream with the hearing device to a user of the hearing device;
inputting the audio stream into at least one acoustic environment classifier of the hearing device, which outputs at least one acoustic environment classification value indicative of an acoustic environment of the user;
determining a new set of actuator strengths based on the at least one acoustic environment classification value;
receiving at least one input stream determined from sensor data of a sensor of the hearing device;
determining at least one change rate for the at least one input stream;
determining at least one change parameter for an actuator change from the actual set of actuator strengths to the new set of actuator strengths;
controlling the at least one actuator, such that the actual set of actuator strengths changes to the new set of actuator strengths in dependence of the at least one change parameter.

2. The method of claim 1,
wherein the at least one change parameter comprises a time delay until a start of the actuator change;
the method further comprising:
waiting the time delay before starting to change the actuator strengths.

3. The method of claim 1,
wherein the at least one change parameter comprises at least one slew rate for the actuator strengths;
the method further comprising:
changing the actuator strengths from the actual set of actuator strengths to the new set of actuator strengths with the at least one slew rate.

4. The method of claim 1, further comprising:
receiving at least two input streams determined from sensor data of at least two sensors of the hearing device;
determining a change rate for each input stream;
determining the at least one change parameter from the change rates of the input streams.

5. The method of claim 1,
wherein the input stream is based on at least one of:
audio data of a microphone;
motion data of a motion sensor;
physiological data of a physiological sensor.

6. The method of claim 1,
wherein at least one input stream is or is determined from the audio stream, which is provided by a microphone of the hearing device.

7. The method of claim 1,
wherein at least one input stream is or is determined from a further sensor data stream from a sensor different from a microphone of the hearing device.

8. The method of claim 1,
wherein at least one input stream is determined by classification values output by a classifier, which are determined by the classifier over time.

9. The method of claim 8,
wherein the classifier is a classifier, which outputs are used for determining a new set of actuator strengths.

10. The method of claim 1,
wherein the new set of actuator strengths is determined from a hearing program, which is stored in the hearing device.

11. The method of claim 1,
wherein the new set of actuator strengths is determined from a mixture of hearing programs stored in the hearing device.

12. The method of claim 1,
wherein the actuators comprise at least one of:
an actuator for frequency dependent amplification;
an actuator for frequency shifting and compressing;
an actuator for frequency compressing;
an actuator for noise canceling;
an actuator for beam forming.

13. A computer program for controlling a hearing device, which, when being executed by a processor, is adapted to carry out the steps of the method of claim 1.

14. A hearing device, comprising:
a microphone;
a sound output device;
at least one actuator;
at least one classifier;
wherein the hearing device is adapted for performing the method of claim 1.
